(19) United States
(12) Patent Application Publication
(10) Pub. No.: US 2022/0338176 A1
(43) Pub. Date: Oct. 20, 2022

(54) METHOD AND APPARATUS FOR DESIGNING A CORESET FOR A UE SUPPORTING NR IOT APPLICATION

(71) Applicant: LENOVO (BEIJING) LIMITED, Beijing (CN)

(72) Inventors: Haipeng Lei, Beijing (CN); Zhi Yan, Beijing (CN); Xiaodong Yu, Beijing (CN); Lianhai Wu, Beijing (CN)

(21) Appl. No.: 17/635,555

(22) PCT Filed: Aug. 16, 2019
(86) PCT No.: PCT/CN2019/101099

§ 371 Date: Feb. 15, 2022

(51) Int. Cl. H04W 72/04; H04L 5/00

(52) U.S. Cl. CPC H04W 72/042; H04L 5/0048; H04L 5/0007

(57) ABSTRACT

The present application is related to a method and apparatus for designing a control-resource set (CORESET) for a user equipment (UE) supporting New Radio (NR) Internet of Things (IoT) application in 3GPP 5G technology. A method for wireless communications performed by a base station (BS) includes: transmitting, to a UE, signaling configuring a control region on a wideband carrier, wherein the control region occupies more than three orthogonal frequency division multiplexing (OFDM) symbols in time domain; and transmitting, to the UE, a downlink control channel within the control region.

### TECHNICAL FIELD

Embodiments of the present application generally relate to in 3rd Generation Partnership Project (3GPP) 5G wireless communication technology, especially to a technology for designing a control-resource set (CORESET) for a user equipment (UE) supporting New Radio (NR) Internet of Things (IoT) application.

### BACKGROUND

In 3GPP Release 17, NR based IoT application is also named as NR-lite, NR-light, NR machine type communication (MTC), NR IoT or massive MTC (mMTC). 3GPP 5G NR based IoT application is targeted to address new use cases with IoT-type requirements that cannot be met by LTE enhanced machine type communication (eMTC) application and LTE Narrow Band (NB)-IoT application. For example, IoT-type requirements include low-complexity, enhanced coverage, long battery life, massive number of devices, higher data rate and/or lower latency. 3GPP 5G NR-IoT application aims to satisfy some of these requirements that cannot be achieved by LTE eMTC application and LTE NB-IoT application. To achieve the above goal, technologies designing a CORESET for UE supporting NR IOT application are developed.

### SUMMARY

Some embodiments of the present application provide a method for wireless communications performed by a base station (BS). The method includes: transmitting, to a user equipment (UE), signaling configuring a control region on a wideband carrier, wherein the control region occupies more than three orthogonal frequency division multiplexing (OFDM) symbols in time domain; and transmitting, to the UE, a downlink control channel within the control region.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a BS.

Some embodiments of the present application provide a method for wireless communications performed by a UE. The method includes: receiving, from a BS, signaling configuring a control region on a wideband carrier, wherein the control region occupies more than three OFDM symbols in time domain; and receiving, from the BS, a downlink control channel within the control region.

Some embodiments of the present application provide an apparatus for wireless communications. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the above-mentioned method performed by a UE.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary IoT subband deployment in accordance with some embodiments of the present application.

FIG. 3 illustrates an exemplary CORESET configuration in accordance with some embodiments of the present application.

FIG. 4 illustrates a further exemplary CORESET configuration in accordance with some embodiments of the present application.

FIG. 5 illustrates an additional exemplary CORESET configuration in accordance with some embodiments of the present application.

FIG. 6 illustrates an additional exemplary CORESET configuration in accordance with some embodiments of the present application.

FIG. 7 illustrates an additional exemplary CORESET configuration in accordance with some embodiments of the present application.

FIG. 8 illustrates another exemplary CORESET configuration in accordance with some embodiments of the present application.

FIG. 9 illustrates an additional exemplary CORESET configuration in accordance with some embodiments of the present application.

FIG. 10 illustrates a flow chart of a method for wireless communications in accordance with some embodiments of the present application.

FIG. 11 illustrates another flow chart of a method for wireless communications in accordance with some embodiments of the present application.

FIG. 12 illustrates a block diagram of an exemplary apparatus in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

FIG. 1 illustrates a schematic diagram of a wireless communication system in accordance with some embodiments of the present application.

As shown in FIG. 1, a wireless communication system 100 includes at least one user equipment (UE) 101 and at least one base station (BS) 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present application, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate directly with BSs 102 via uplink (UL) communication signals.

In some embodiments of the present application, each of the UE(s) 101 may be deployed an IoT application, an eMBB application and/or a URLLC application. For instance, UE 101a may implement an IoT application and may be named as an IoT UE, while UE 101b may implement an eMBB application and/or a URLLC application and may be named as an eMBB UE, an URLLC UE, or an eMBB/URLLC UE. It is contemplated that the specific type of application(s) deployed in the UE(s) 101 may be varied and not limited.

The BS(s) 102 may be distributed over a geographic region. In certain embodiments of the present application, each of the BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. The BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an OFDM modulation scheme on the DL and the UE(s) 101 transmit data on the UL using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, the BS(s) 102 may communicate using other communication protocols, such as the IEEE 802.11 family of wireless communication protocols. Further, in some embodiments of the present application, the BS(s) 102 may communicate over licensed spectrums, whereas in other embodiments, the BS(s) 102 may communicate over unlicensed spectrums. The present application is not intended to be limited to the implementation of any particular wireless communication system architecture or protocol. In yet some embodiments of present application, the BS(s) 102 may communicate with the UE(s) 101 using the 3GPP 5G protocols.

In 3GPP LTE eMTC protocol, the physical layer channel design is based on the bandwidth of 1.4 MHz, because 1.4 MHz is the minimum supported LTE bandwidth. With the minimum bandwidth of 1.4 MHz, an eMTC device may greatly reduce cost and an implementation complexity. The 1.4 MHz bandwidth includes 6 Physical Resource Blocks (PRB(s)), wherein LTE Primary synchronization signal (PSS), Secondary synchronization signal (SSS), and Physical broadcast channel (PBCH) are accommodated in these 6 PRBs. Hence, a UE with 1.4 MHz bandwidth capability can access a wideband carrier with a bandwidth larger than 1.4 MHz. Furthermore, to exploit frequency diversity gain, a UE with 1.4 MHz bandwidth capability can dynamically change its operating bandwidth from one subband to another subband, wherein each subband has a bandwidth of 1.4 MHz.

In 3GPP NR Release 15, the minimum bandwidth is defined as 5 MHz. PSS, SSS and PBCH are designed to occupy 20 resource blocks (RBs) regardless of the subcarrier spacing. Therefore, for NR IoT application, if the minimum bandwidth is smaller than 5 MHz with 15 kHz subcarrier spacing, or if the minimum bandwidth is smaller than 10 MHz with 30 kHz subcarrier spacing, it is inevitable to redesign new PSS/SSS/PBCH, which leads to huge standardization efforts. Thus, 5 MHz should be the minimum bandwidth for NR IoT application for subcarrier spacing of 15 kHz. In addition, 10 MHz should be the minimum bandwidth for NR IoT application for subcarrier spacing of 30 kHz.

Existing NR UE costs in terms of implementation, complexity, and power consumption are very high. For example, a NR UE may require 100 MHz bandwidth for FR1 or 200 MHz bandwidth for FR2, at least 2 Rx antennas or 4 Rx antennas, dynamic Time Division Duplexing (TDD), 15 kHz, 30 kHz, or 60 kHz subcarrier spacing (SCS) for FR1, no always-on signals, and etc. Thus, it is necessary to tailor the existing NR features in terms of cost, implementation complexity and power consumption for NR IoT use cases. In addition, existing NR coverage may not meet requirements of NR IoT application. Hence, coverage enhancement for NR IoT application is also necessary.

Embodiments of the present application aim to provide solutions for designing a CORESET for a UE supporting NR IoT application, so as to further improve channel utilization efficiency and downlink control channel transmission efficiency. More details on embodiments of the present application will be illustrated in the following text in combination with the appended drawings.

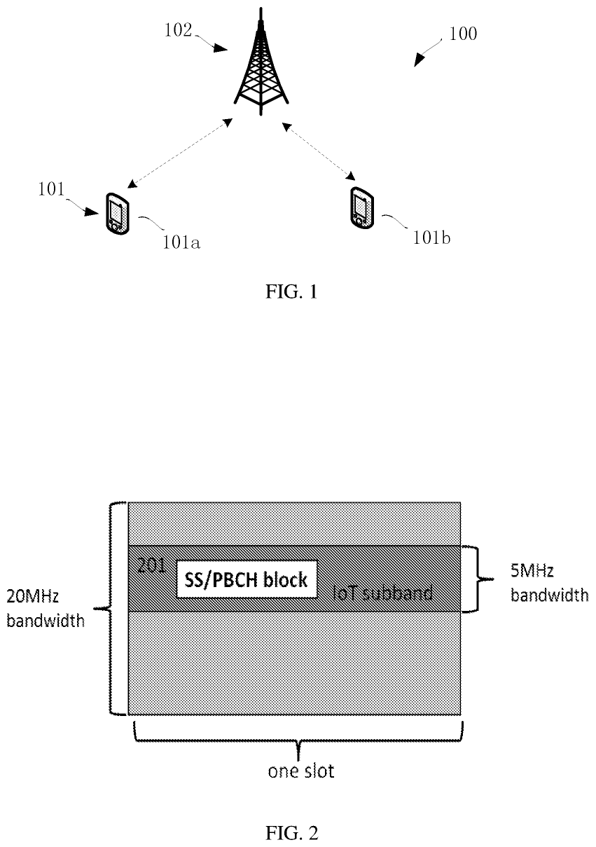

FIG. 2 illustrates an exemplary IoT subband deployment in accordance with some embodiments of the present application. The embodiments of FIG. 2 deploy NR IoT application in a wideband carrier within one slot. As shown in FIG. 2, a wideband carrier of 20 MHz bandwidth within one slot is used to deploy NR IoT application, eMBB application, and/or URLLC application. For example, subband 201 with 5 MHZ bandwidth is used to deploy NR IoT application as shown in FIG. 2.

A synchronization signal (SS)/PBCH block is also named as SSB or NR SSB. In some embodiments, SSB may be transmitted using 15 kHz subcarrier spacing and occupies 20 RBs in the frequency domain. When NR IoT application is deployed, a simple way is to reuse the existing SSB and an initial access procedure for an IoT UE, such that the IoT UE can access the channel. Accordingly, the IoT UE should have minimum 5 MHz bandwidth capability with 15 kHz subcarrier spacing or minimum 10 MHz bandwidth capability with 30 kHz subcarrier spacing, in order to reuse the existing NR SSB to access the channel, without designing a new SSB.

In the embodiments of FIG. 2, assuming 5 MHz bandwidth having 15 kHz subcarrier spacing is used for NR IoT application, the IoT UE will search the SSB (e.g., SS/PBCH block as shown in FIG. 2) according to sync raster and the given frequency band. After the IoT UE finishes the initial access procedure, the IoT UE may transmit or receive signals on the 5 MHz bandwidth having 15 kHz subcarrier spacing. From the perspective of this IoT UE, it is working on a carrier with 5 MHz bandwidth.

In some embodiments of the present application, a NR IoT bandwidth is fixed to 5 MHz and the subcarrier spacing for NR IoT bandwidth is fixed to 15 kHz. In some other embodiments, the NR IoT bandwidth is fixed to 10 MHz and the subcarrier spacing for NR IoT bandwidth is fixed to 30 kHz. In some additional embodiments, the NR IoT bandwidth is configurable among 5 MHz, 10 MHz, 15 MHz, 20 MHz or other bandwidths, and the subcarrier spacing of the NR IoT bandwidth is configurable between 15 kHz, 30 kHz or other values.

A more generic control channel structure designed in NR is a CORESET. A CORESET is a configured time-frequency resource where UE attempts to decode a downlink control channel in one or more search spaces. For example, UE may attempt to decode a Physical Downlink Control Channel (PDCCH) in one or more search spaces with a CORESET. Different from LTE PDCCH, NR PDCCH does not necessarily span the full wideband carrier, because not all NR UEs may be able to receive the full wideband carrier. The size and the location of a CORESET in a time-frequency domain may be semi-statically configured by a BS. Thus, the size of a CORESET may be set to be smaller than a wideband carrier. A CORESET is defined from a UE perspective and only indicates where UE may detect the downlink control channel (e.g., PDCCH). A CORESET in NR may have fixed size.

NR PDCCH consists of 1, 2, 4, 8 or 16 control-channel elements (CCEs) depending on different channel conditions and coverage requirements. A CCE consists of 6 resource-element groups (REGs). A REG represents one resource block (RB) in frequency domain and one OFDM symbol in time domain. In the time domain, a CORESET may be up to three OFDM symbols in duration and is usually located at the beginning of a slot. Demodulation Reference Signal (DMRS) for PDSCH may be located in the third OFDM symbol or fourth OFDM symbol within one slot. In response to DMRS for PDSCH is located in the third OFDM symbol of a slot, the maximum duration for a CORESET occupies two OFDM symbols. In response to DMRS for PDSCH is located in the fourth OFDM symbol of a slot, the maximum duration for a CORESET occupies three OFDM symbols. However, in some cases, such CORESET configuration cannot accommodate one PDCCH with a specific aggregation level (AL).

Specifically, as defined in 3GPP 5G TS38.101, when NR IoT is deployed with 5 MHz bandwidth and 15 kHz subcarrier spacing, the maximum number of available RBs is 25. In Table 7.3.2.1-1 of 3GPP 5G TS38.211, a set of AL is defined. Since each CCE comprises 6 REGs, in response to maximum 3 OFDM symbols being configured for a CORESET, the CORESET occupies 75 REGs, which indicates that only 12 CCEs are available in the CORESET. When NR IoT requires coverage enhancement or reliability improvement for PDCCH, such CORESET configuration cannot accommodate one PDCCH with an AL of 16, because one PDCCH with an AL of 16 requires at least 16 CCEs. On the other hand, a CORESET configuration in the frequency domain is defined in multiples of six common resource block (CRBs). From a perspective of an IoT UE, it is possible that six CRBs are not aligned with the first PRB of the NR IoT bandwidth. Due to this reason, the total number of available REGs in the CORESET is further reduced.

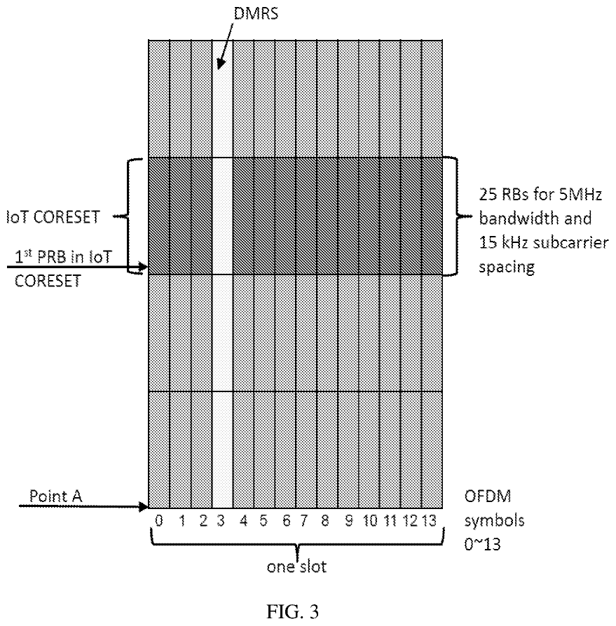

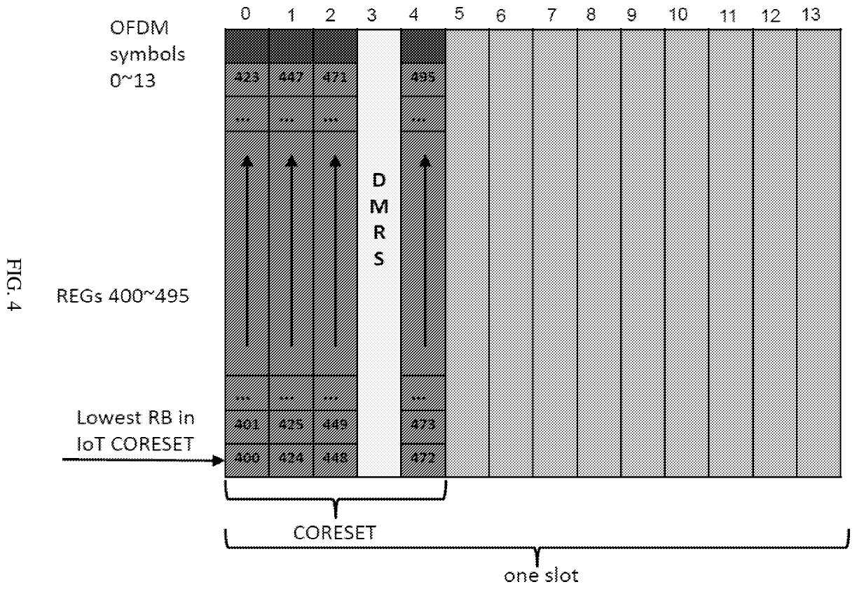

FIG. 3 illustrates an exemplary CORESET configuration in accordance with some embodiments of the present application. In the embodiments of FIG. 3, one slot includes OFDM symbols 0˜13. Point A in FIG. 3 represents a location of subcarrier 0 of CRB 0, which is used as a common reference for RB indexing.

As shown in FIG. 3, 5 MHz bandwidth is used to deploy NR IoT application. With a 15 kHz subcarrier spacing, maximum 25 RBs are available. When the 1^{st} PRB in IoT CORESET is aligned with the first CRB of one six-CRB group, maximum 24 RBs are configurable for a NR IoT CORESET. When a master information block (MIB) indicates that a DMRS is located in OFDM symbol 3 as marked in FIG. 3, the NR IoT CORESET may have maximum three OFDM symbols in a time domain, i.e., OFDM symbols 0˜2. Since each CCE comprises 6 REGs, the NR IoT CORESET comprises 72 REGs (24×3=72 REGs) and 12 CCEs. Obviously, the 12 CCEs within the NR IoT CORESET can only support one PDCCH with maximum AL of 8. Under this case, for the purpose of coverage enhancement and reliability improvement, a CORESET configuration and a PDCCH need to be enhanced.

In some embodiments of the present application, a duration in time domain and a bandwidth in frequency domain of a NR IoT CORESET are preconfigured or configured by Radio Resource Control (RRC) signaling. For instance, a time domain duration for one NR IoT CORESET is configured with more than 3 OFDM symbols, and the CORESET configuration for NR IoT ensures that the NR IoT CORESET is not across a slot boundary between two slots.

For example, a NR IoT CORESET may be configured to include 4, 5, 6, 7, 8, 9, 10, 11, 12, 13, or 14 OFDM symbols within one slot. For a further example, a NR IoT CORESET may be configured to include a number of OFDM symbols within one slot, and the total number of OFDM symbols is an integer multiple of 6.

A NR IoT CORESET with more than 3 OFDM symbols within one slot may be consecutive in time domain. On the other hand, since MIB-indicated DMRS may exist in an OFDM symbol (e.g., OFDM symbol 2 or OFDM symbol 3), a NR IoT CORESET with more than 3 OFDM symbols may be non-consecutive in time domain. If a NR IoT CORESET includes a MIB-indicated DMRS which is located in OFDM symbol 2 or OFDM symbol 3, the MIB-indicated DMRS in OFDM symbol 2 or OFDM symbol 3 is not included in the NR IoT CORESET.

A REG represents one RB in frequency domain and one OFDM symbol in time domain. Considering a variable duration of a NR IoT CORESET in time domain and the variable duration of the NR IoT CORESET may not be a factor of 6 or an integer multiple of 6, embodiments of the present application redesign the numbering of REGs compared to NR Release 15 standard documents.

A REG represents one RB during one OFDM symbol. In some embodiments of the present application, within a NR IoT CORESET, REGs are numbered in an increasing order in a frequency-first time-second manner. In particular, in the first OFDM symbol of a NR IoT CORESET, starting from REG 0 for the lowest-numbered RB in the CORESET, then increasing REG number for the second lowest-numbered RBs in the CORESET till the highest-numbered RBs in the CORESET; then in the second OFDM symbol of the CORESET, increasing REG number from the lowest-numbered RBs in the CORESET till the highest-numbered RBs in the CORESET; then, repeating the procedure in the third OFDM symbol of the CORESET till the last OFDM symbol of the CORESET.

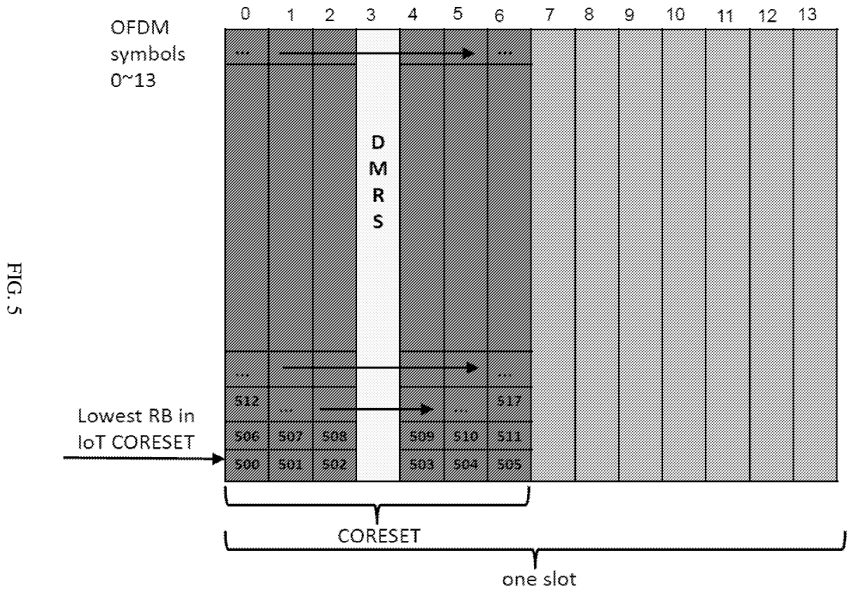

Such embodiments may keep 6 REGs for one CCE and keep the frequency domain resource configuration for a CORESET in a bitmap with each bit in the bitmap corresponding to 6 contiguous RBs. In other words, the total number of RBs for a CORESET is an integer multiple of 6, which is well aligned with the size of one CCE. A specific example is shown in FIG. 4.

FIG. 4 illustrates a further CORESET configuration in accordance with some embodiments of the present application. Similar to the embodiments of FIG. 3, in the embodiments of FIG. 4, one slot includes OFDM symbols 0˜13 and a DMRS is located in OFDM symbol 3 as marked in FIG. 4. A NR IoT CORESET as shown in FIG. 4 includes 4 OFDM symbols (i.e., OFDM symbols 0˜2 and OFDM symbol 4) and includes REGs 400˜495 in total. Moreover, the CORESET as shown in FIG. 4 is configured with a frequency-first time-second REG numbering manner. In other words, within the NR IoT CORESET as shown in FIG. 4, REGs are numbered in an increasing order in a frequency-first time-second manner.

As shown in FIG. 4, since MIB-indicated DMRS exists in OFDM symbol 3, the NR IoT CORESET with 4 OFDM symbols is non-consecutive in time domain. For instance, REG 400 represents the lowest RB in IoT CORESET during OFDM symbol 0; REG 424 represents the lowest RB in IoT CORESET during OFDM symbol 1; REG 448 represents the lowest RB in IoT CORESET during OFDM symbol 2; and REG 472 represents the lowest RB in IoT CORESET during OFDM symbol 4.

Specifically, according to the embodiments of FIG. 4, in OFDM symbol 0 of the CORESET, starting from REG 400 for the lowest-numbered RB in the CORESET, then increasing REG number for the second lowest-numbered RBs in the CORESET (i.e., REG 401) till the highest-numbered RBs in the CORESET (i.e., REG 423); in OFDM symbol 1 of the CORESET, increasing REG number from the lowest-numbered RBs in the CORESET (i.e., REG 424) till the highest-numbered RBs in the CORESET (i.e., REG 447); in OFDM symbol 2 of the CORESET, increasing REG number from the lowest-numbered RBs in the CORESET (i.e., REG 448) till the highest-numbered RBs in the CORESET (i.e., REG 471); and then, in OFDM symbol 4 of the CORESET, increasing REG number from the lowest-numbered RBs in the CORESET (i.e., REG 472) till the highest-numbered RBs in the CORESET (i.e., REG 495).

More specifically, in the embodiments of FIG. 4, NR IoT application is deployed with 5 MHz bandwidth and 15 kHz subcarrier spacing, and there are maximum 25 RBs available for transmission. Accordingly, there are maximum 25 REGs available for transmission in each OFDM symbol. In the case that there are 25 REGs available for transmission in OFDM symbol 0, only the first REG (i.e., REG 400) to the twenty-fourth REG (i.e., REG 423) in OFDM symbol 0 may be configured to be included in a NR IoT CORESET, because maximum 24 REGs are configurable for the CORESET in frequency domain, where 24 is a multiple of 6. In other words, the CORESET does not include the twenty-fifth REG in OFDM symbol 0. Similarly, as shown in FIG. 4, the CORESET does not include the twenty-fifth REG in each of OFDM symbols 1, 2, and 4. Hence, the embodiments of FIG. 4 keep 6 REGs for one CCE and keep the frequency domain resource configuration for a CORESET in a bitmap with each bit in the bitmap corresponding to 6 contiguous RBs.

In some other embodiments of the present application, within a NR IoT CORESET, REGs are numbered in an increasing order in a time-first frequency-second manner. In particular, within a NR IoT CORESET, starting with REG 0 for the lowest-numbered RB in the CORESET and in the first OFDM symbol of the CORESET, then increasing REG number for the second OFDM symbol of the CORESET till the last OFDM symbol of the CORESET; then, in the second lowest-numbered RB in the CORESET, increasing REG number from the first OFDM symbol in the CORESET till the last OFDM symbol in the CORESET; and repeating the procedure in the third lowest-numbered RB of the CORESET till the highest-numbered RB in the CORESET.

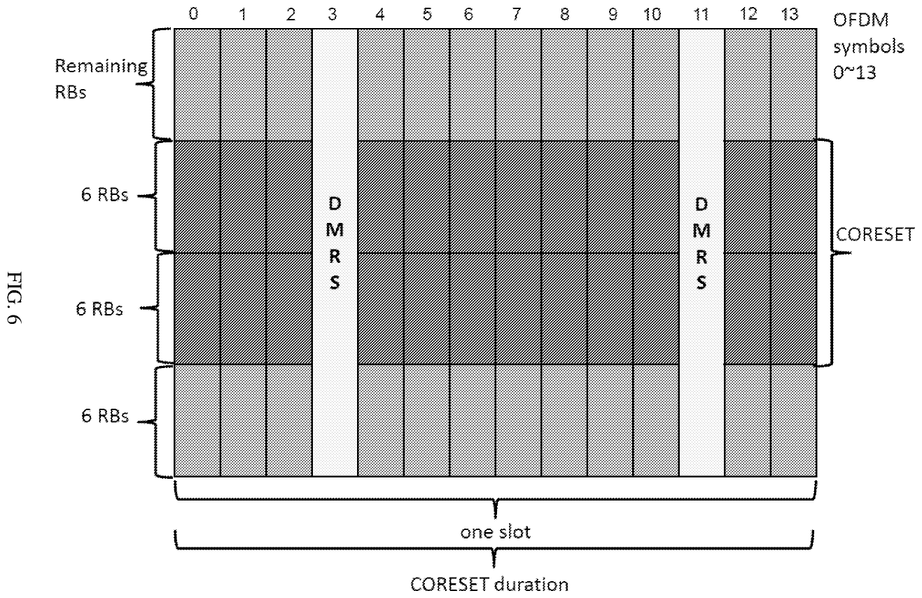

Such embodiments keep the REG numbering order defined in NR Release 15. However, the limitation on a duration of a NR IoT CORESET is needed, i.e., a duration of a NR IoT CORESET should be a factor of 6 or an integer multiple of 6. For example, a duration of one NR IoT CORESET may be 1, 2, 3, 6, or 12 consecutive OFDM symbols in one slot. It is noted that 1, 2 or 3 OFDM symbols cannot accommodate PDCCH(s) with a high AL. 6 or 12 OFDM symbols can easily bundle 6 consecutive REGs into one CCE. A specific example is shown in FIG. 5.

FIG. 5 illustrates an additional exemplary CORESET configuration in accordance with some embodiments of the present application. Similar to the embodiments of FIGS. 3 and 4, in the embodiments of FIG. 5, one slot includes OFDM symbols 0˜13 and a DMRS is located in OFDM symbol 3 as marked in FIG. 5. A NR IoT CORESET as shown in FIG. 5 includes 6 OFDM symbols (i.e., OFDM symbols 0˜2 and OFDM symbols 4˜6) and includes REGs starting from REG 500. Moreover, the CORESET as shown in FIG. 5 is configured with a time-first frequency-second REG numbering manner. In other words, within the NR IoT CORESET as shown in FIG. 5, REGs are numbered in an increasing order in a time-first frequency-second manner.

As shown in FIG. 5, since MIB-indicated DMRS exists in OFDM symbol 3, the NR IoT CORESET with 6 OFDM symbols is non-consecutive in time domain. For instance, REG 500 represents the lowest RB in IoT CORESET during OFDM symbol 0; REG 501 represents the lowest RB in the CORESET during OFDM symbol 1; REG 502 represents the lowest RB in the CORESET during OFDM symbol 2; REG 503 represents the lowest RB in the CORESET during OFDM symbol 4; REG 504 represents the lowest RB in the CORESET during OFDM symbol 5; and REG 505 represents the lowest RB in the CORESET during OFDM symbol 6.

More specifically, according to the embodiments of FIG. 5, in the NR IoT CORESET, starting from REG 500 for the lowest-numbered RB in the CORESET and in OFDM symbol 0 of the CORESET, then increasing to REG number for OFDM symbol 1 of the CORESET (i.e., REG 501), REG number for OFDM symbol 2 of the CORESET (i.e., REG 502), REG number for OFDM symbol 4 of the CORESET (i.e., REG 503), REG number for OFDM symbol 5 of the CORESET (i.e., REG 504) and REG number for OFDM symbol 6 of the CORESET (i.e., REG 505) in order, respectively; then, in the second lowest-numbered RB in the CORESET, increasing REG number from OFDM symbol 0 in the CORESET (i.e., REG 506) till OFDM symbol 6 in the CORESET (i.e., REG 511); and repeating the procedure in the third lowest-numbered RB of the CORESET (i.e., REG 512 to REG 517) till the highest-numbered RB in the CORESET (the specific REG number are not labeled in FIG. 5). It can be contemplated that, in the embodiments of FIG. 5, 6 OFDM symbols can easily bundle 6 consecutive REGs into one CCE for the CORESET.

In some embodiments of the present application, two or more REGs may be bundled into one REG bundle for precoding. In particular, a size of one REG bundle may be configured by RRC signaling according to frequency domain and time domain configuration of a CORESET. A granularity of a pre-coder may be configured to a size of one REG bundle. Alternatively, a granularity of a pre-coder may be configured to all contiguous RBs in frequency domain.

For example, a total number of REGs within one REG bundle is configured by RRC signaling in the frequency domain. For instance, regardless of a duration of a CORESET in time domain, 2, 3, 6, 12, 18, 24, 48, or 96 REGs may be bundled into one REG bundle, and accordingly, the size of the REG bundle is 2, 3, 6, 12, 18, 24, 48, or 96 REGs.

For a further example, a total number of REGs within one REG bundle is configured by RRC signaling in the time domain. Under this scenario, the size of a REG bundle may be an integer multiple of 6, 12, 18, 24, 48, 96, and so on. For instance, the size of a REG bundle is 12 REGs in case that 6 REGs in frequency domain and 2 OFDM symbols in time domain are bundled together; the size of a REG bundle is 18 REGs in case that 6 REGs in frequency domain and 3 OFDM symbols in time domain are bundled together; the size of a REG bundle is 24 REGs in case that 6 REGs in frequency domain and 4 OFDM symbols in time domain are bundled together; the size of a REG bundle is 48 REGs in case that 6 REGs in frequency domain and 8 OFDM symbols in time domain are bundled together or in case that 12 REGs in frequency domain and 4 OFDM symbols in time domain are bundled together.

Since one slot includes 14 OFDM symbols in total (e.g., OFDM symbols 0˜13 as shown in FIGS. 2-9), a time domain duration of a long CORESET may be of 13 OFDM symbols without considering a MIB-indicated DMRS existing in OFDM symbol 2 or OFDM symbol 3 within the slot. Alternatively, the time domain duration of the long CORESET may be of 12 OFDM symbols without considering a MIB-indicated DMRS existing in OFDM symbol 2 or OFDM symbol 3 and an additional DMRS existing in an additional OFDM symbol within the slot.

In some embodiments of the present application, a long CORESET occupies a part of the NR IoT bandwidth. The part of the NR IoT bandwidth comprises one or more resource block groups (RBGs) in frequency domain, and each RBG comprises a predefined number of contiguous resource blocks in the frequency domain. For instance, since the CORESET in frequency domain is configured in a group of 6 contiguous RBs, the frequency resource of the CORESET can occupy one or more RBGs, and each RBG includes 6 RBs. One or more RBGs may be contiguous in frequency domain for frequency selectivity gain and more accurate channel estimation. In this case, a granularity of a pre-coder may be set to all contiguous RBs in frequency domain. The remaining RBs in frequency domain may be used for PDSCH transmission. A specific example is shown in FIG. 6.

FIG. 6 illustrates an additional exemplary CORESET configuration in accordance with some embodiments of the present application. FIG. 6 refers to a contiguous CORESET configuration in frequency domain for NR IoT application. Similar to the embodiments of FIGS. 3-5, in the embodiments of FIG. 6, one slot includes OFDM symbols 0˜13 and two DMRS symbols for PDSCH demodulation are located in OFDM symbols 3 and 11 as marked in FIG. 6. The CORESET duration in embodiments of FIG. 6 is one slot.

According to the embodiments of FIG. 6, assuming two RBGs and 12 OFDM symbols are configured for the NR IoT CORESET, there are 144 REGs (2×12×6=144 REGs) in total within the CORESET, and thus there are maximum 24 CCEs (144 REGs/6=24 CCEs) available for transmission. 24 CCEs can accommodate one PDCCH with AL of 16 and another PDCCH with AL of 8.

More specifically, according to the embodiments of FIG. 6, each OFDM symbol includes three groups of 6 RBs (i.e., three RBGs) and the remaining RBs in frequency domain, and the NR IoT CORESET includes consecutive two RBGs (e.g., the second and third groups of 6 RBs as shown in FIG. 6, i.e., the second and third RBGs). The remaining RBs in frequency domain in each OFDM symbol may be used for PDSCH transmission or PDCCH transmission for other UE(s).

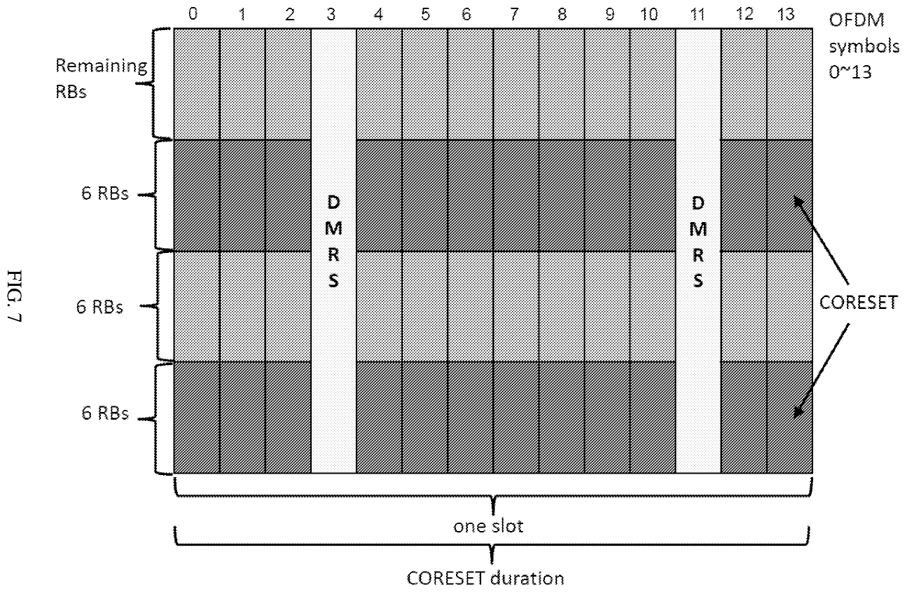

In some other embodiments of the present application, the long CORESET occupies a part of the NR IoT bandwidth, the frequency resource of the long CORESET may occupy one or more RBGs that are non-contiguous in frequency domain for frequency diversity gain. The remaining RBs in frequency domain may be used for PDSCH transmission. A specific example is shown in FIG. 7.

FIG. 7 illustrates an additional exemplary CORESET configuration in accordance with some embodiments of the present application. FIG. 7 refers to a non-contiguous CORESET configuration in frequency domain for NR IoT application. As depicted in FIG. 7, two non-consecutive RBGs (e.g., the first and third groups of 6 RBs) are used as CORESET. Similar to the embodiments of FIGS. 3-6, in the embodiments of FIG. 7, one slot includes OFDM symbols 0˜13 and two DMRS symbols for PDSCH demodulation are located in OFDM symbols 3 and 11 as marked in FIG. 7. The CORESET duration in embodiments of FIG. 7 is one slot.

According to the embodiments of FIG. 7, assuming two RBGs and 12 OFDM symbols are configured for the NR IoT CORESET, there are 144 REGs (2×12×6=144 REGs) in total within the CORESET, and thus there are maximum 24 CCEs (144 REGs/6=24 CCEs) available for transmission. 24 CCEs can accommodate one PDCCH with AL of 16 and another PDCCH with AL of 8.

More specifically, according to the embodiments of FIG. 7, each OFDM symbol includes three groups of 6 RBs (i.e., three RBGs) and the remaining RBs in frequency domain, and the NR IoT CORESET includes non-consecutive two RBGs (e.g., the first and third groups of 6 RBs as shown in FIG. 7, i.e., the first and third RBGs). The remaining RBs in frequency domain in each OFDM symbol may be used for PDSCH transmission.

In the case that a MIB-indicated DMRS exists in OFDM symbol 2 or OFDM symbol 3, for short CORESET configuration with full NR IoT bandwidth (for example, in the embodiments of FIGS. 4 and 5), OFDM symbol 2 or OFDM symbol 3 is left empty in the region of NR IoT bandwidth. This avoids interference of neighboring cells to the DMRS.

In the case that a MIB-indicated DMRS exists in OFDM symbol 2 or OFDM symbol 3, for long CORESET configuration with partial NR IoT bandwidth (for example, in the embodiments of FIGS. 6 and 7), OFDM symbol 2 or OFDM symbol 3 is left empty in the region of NR IoT CORESET and used as the DMRS in the data region of the NR IoT bandwidth.

For a CORESET including 4 OFDM symbols within 5 MHz bandwidth (for example, in the embodiments of FIG. 4), each OFDM symbol include 24 REGs available, and there are 96 REGs available in total in the CORESET which correspond to 16 CCEs in the CORESET. Therefore, the CORESET including 4 OFDM symbols is the minimum duration to accommodate a PDCCH with AL of 16. In some embodiments, CORESET 0, where PDCCH is transmitted for scheduling system information block (SIB) during initial access procedure, has a default duration of 4 OFDM symbols and a default width of 24 contiguous RBs. In some other embodiments, a duration and/or a width of CORESET 0 is configured by RRC signaling, and the width of CORESET 0 is configured as a number of RBGs with the number indicated in MIB.

In some other embodiments of the present application, an offset between an index of the lowest numbered RB in the control resource set and an index of a lowest numbered RB in the wideband carrier relative to same subcarrier spacing is an integer multiple of 6. The lowest numbered RB in the wideband carrier may be CRB 0 with subcarrier 0 of CRB 0 coincided with Point A (e.g., Point A as shown in FIG. 3). A NR IoT CORESET configuration in frequency domain aligns a boundary of a group of 6 contiguous CRBs. For example, groups of 6 RBs in the embodiments of FIGS. 6 and 7 may align boundary(s) between groups of 6 CRBs within the NR IoT bandwidth. The index of a CRB corresponding to the lowest-numbered RB within a NR IoT bandwidth is an integer multiple of 6. In this way, since maximum 24 REGs are configurable for a NR IoT CORESET, maximum four groups of 6 CRBs within the NR IoT bandwidth can be configured for the NR IoT CORESET.

According to some embodiments of the present application, two or more CORESETs are configured in the same slot and the two or more CORESETs in the slot are combined for transmitting one PDCCH with a high aggregation level (AL). A duration of each CORESET of the combined CORESET is not larger than 3 contiguous OFDM symbols, and the duration of each CORESET is related to a DMRS position in OFDM symbol indicated in MIB.

For instance, if OFDM symbol 2 is indicated in MIB for the DMRS, the duration of each CORESET is not larger than 2 due to existence of DMRS in OFDM symbol 2. Alternatively, the duration of the first CORESET may be not larger than 2, while other CORESETs may have a duration of more than 2 OFDM symbols. If OFDM symbol 3 is indicated in MIB for the DMRS, the duration of each CORESET is not larger than 3 due to existence of DMRS in OFDM symbol 3. Alternatively, the duration of the first CORESET may be not larger than 3, while other CORESETs may have a duration of more than 3 OFDM symbols.

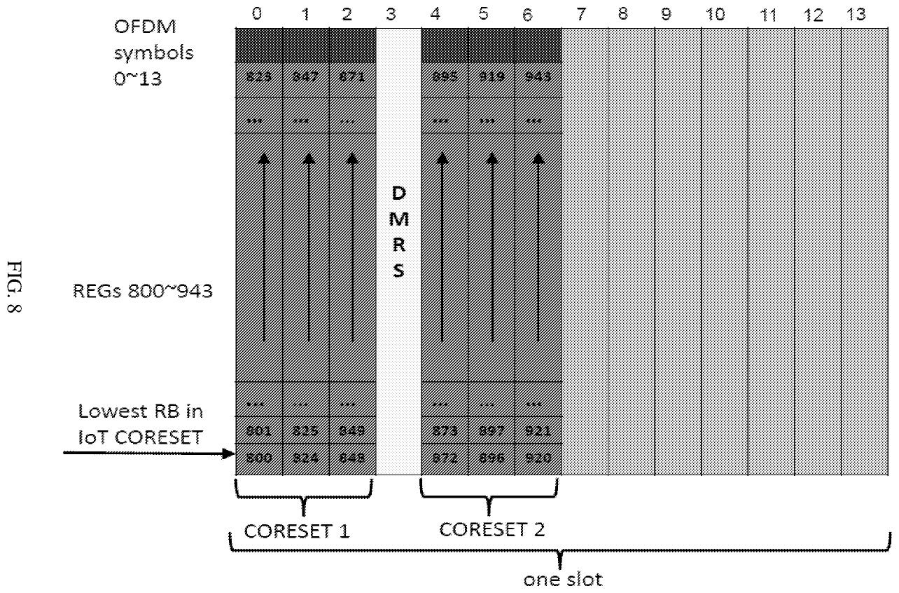

According to the embodiments as described above, similar to the embodiments in FIG. 4, REG numbering in each CORESET of the combined CORESET may be in a frequency-first time-second manner. Alternatively, similar to the embodiments in FIG. 5, REG numbering in each CORESET of the combined CORESET may be in a time-first frequency-second manner. CORESETs in one slot may be concatenated in REG numbering or CCE numbering. When the first CORESET cannot accommodate a PDCCH with a high AL, CCEs in the second CORESET are used starting from the first CCE of the second CORESET to accommodate the PDCCH. A specific example is shown in FIG. 8.

FIG. 8 illustrates another exemplary CORESET configuration in accordance with some embodiments of the present application. In embodiments in FIG. 8, CCEs within two CORESETs are concatenated for one PDCCH transmission and each CORESET uses a frequency-first time-second REG numbering manner.

Similar to the embodiments of FIGS. 3-7, in the embodiments of FIG. 8, one slot includes OFDM symbols 0˜13 and a DMRS is located in OFDM symbol 3 as marked in FIG. 8. A NR IoT CORESET 1 as shown in FIG. 8 includes 3 OFDM symbols (i.e., OFDM symbols 0˜2) and includes REGs 800˜871 in total. A NR IoT CORESET 2 as shown in FIG. 8 includes 3 OFDM symbols (i.e., OFDM symbols 4˜6) and includes REGs 872˜943 in total. Moreover, both the CORESET 1 and the CORESET 2 as shown in FIG. 8 are configured with a frequency-first time-second REG numbering manner.

More specifically, according to the embodiments of FIG. 8, in OFDM symbol 0 of the CORESET 1, starting from REG 800 for the lowest-numbered RB in the CORESET 1, then increasing REG number for the second lowest-numbered RBs in the CORESET 1 (i.e., REG 801) till the highest-numbered RBs in the CORESET 1 (i.e., REG 823); then in OFDM symbol 1 of the CORESET 1, increasing REG number from the lowest-numbered RBs in the CORESET 1 (i.e., REG 824) till the highest-numbered RBs in the CORESET 1 (i.e., REG 847); and then, in OFDM symbol 2 of the CORESET 1, increasing REG number from the lowest-numbered RBs in the CORESET 1 (i.e., REG 848) till the highest-numbered RBs in the CORESET 1 (i.e., REG 871).

Similarly, in OFDM symbol 4 of the CORESET 2, starting from REG 872 for the lowest-numbered RB in the CORESET 2, then increasing REG number for the second lowest-numbered RBs in the CORESET 2 (i.e., REG 873) till the highest-numbered RBs in the CORESET (i.e., REG 895); then in OFDM symbol 5 of the CORESET 2, increasing REG number from the lowest-numbered RBs in the CORESET 2 (i.e., REG 896) till the highest-numbered RBs in the CORESET 2 (i.e., REG 919); and then, in OFDM symbol 6 of the CORESET 2, increasing REG number from the lowest-numbered RBs in the CORESET 2 (i.e., REG 920) till the highest-numbered RBs in the CORESET 2 (i.e., REG 943).

According to the embodiments of FIG. 8, NR IoT application is deployed with 5 MHz bandwidth and 15 kHz subcarrier spacing, and there are maximum 25 RBs available for transmission. Accordingly, there are maximum 25 REGs available for transmission in each OFDM symbol. In the case that there are 25 REGs available for transmission in OFDM symbol 0, only the first REG (i.e., REG 800) to the twenty-fourth REG (i.e., REG 823) in OFDM symbol 0 may be configured to be included in the CORESET 1, because maximum 24 REGs are configurable for the CORESET 1. In other words, the CORESET 1 does not include the twenty-fifth REG in OFDM symbol 0. Similarly, as shown in FIG. 8, the CORESET 1 does not include the twenty-fifth REG in each of OFDM symbols 1 and 2. The CORESET 2 does not include the twenty-fifth REG in each of OFDM symbols 4, 5, and 6. Hence, the embodiments of FIG. 8 keep 6 REGs for one CCE and keep the frequency domain resource configuration for the CORESET 1 and the CORESET 2 in a bitmap with each bit in the bitmap corresponding to 6 contiguous RBs.

According to some other embodiments of the present application, two or more CORESETs are configured in different slots and the two or more CORESETs in different slots are combined for transmitting one PDCCH with a high AL. A duration of each CORESET of the combined CORESET is not larger than 3 OFDM symbols, and the duration of each CORESET is related to a DMRS position in OFDM symbol indicated in MIB. For instance, if OFDM symbol 2 is indicated in MIB for the DMRS, the duration of each CORESET is not larger than 2. If OFDM symbol 3 is indicated in MIB for the DMRS, the duration of each CORESET is not larger than 3.

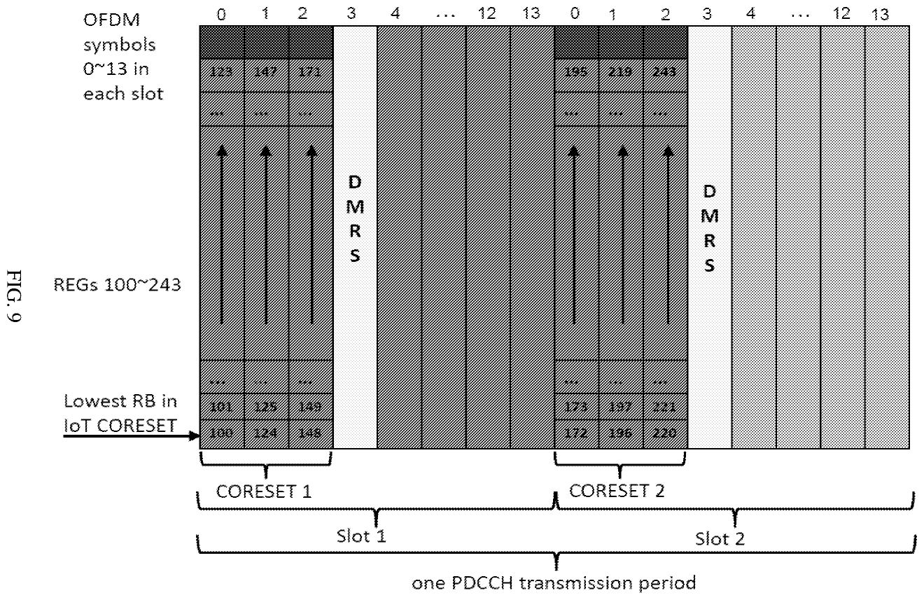

According to the embodiments as described above, the periodicity and offset for one PDCCH transmission may be configured by RRC signaling, where the two or more CORESETs in the periodicity are concatenated in REG numbering or CCE numbering. Similar to the embodiments in FIGS. 4 and 5, REG numbering in each CORESET of the combined CORESET may be in a frequency-first time-second manner or a time-first frequency-second manner. When the first CORESET cannot accommodate a PDCCH with a high AL, CCEs in the second CORESET are used starting from the first CCE of the second CORESET to accommodate the PDCCH. A specific example is shown in FIG. 9.

FIG. 9 illustrates an additional exemplary CORESET configuration in accordance with some embodiments of the present application. In embodiments in FIG. 9, CCEs within two CORESETs are concatenated for one PDCCH transmission, and each CORESET uses a frequency-first time-second REG numbering manner. In other words, in embodiments in FIGS. 3-8, one PDCCH transmission period includes one slot; while in embodiments in FIG. 9, one PDCCH transmission period includes two slots.

Specifically, the embodiments of FIG. 9 show two slots, i.e., Slot 1 and Slot 2. Similar to the embodiments of FIGS. 3-8, in the embodiments of FIG. 9, each slot includes OFDM symbols 0˜13 and a DMRS is located in OFDM symbol 3 within each slot as marked in FIG. 9. A NR IoT CORESET 1 as shown in FIG. 9 includes 3 OFDM symbols (i.e., OFDM symbols 0˜2 in Slot 1) and includes REGs 100˜171 in total. A NR IoT CORESET 2 as shown in FIG. 9 includes 3 OFDM symbols (i.e., OFDM symbols 0˜2 in Slot 2) and includes REGs 172˜243 in total. Moreover, both the CORESET 1 and the CORESET 2 as shown in FIG. 9 are configured with a frequency-first time-second REG numbering manner.

More specifically, according to the embodiments of FIG. 9, in OFDM symbol 0 in Slot 1 of the CORESET 1, starting from REG 100 for the lowest-numbered RB in the CORESET 1, then increasing REG number for the second lowest-numbered RBs in the CORESET 1 (i.e., REG 101) till the highest-numbered RBs in the CORESET 1 (i.e., REG 123); in OFDM symbol 1 in Slot 1 of the CORESET 1, increasing REG number from the lowest-numbered RBs in the CORESET 1 (i.e., REG 124) till the highest-numbered RBs in the CORESET 1 (i.e., REG 147); and then, in OFDM symbol 2 in Slot 1 of the CORESET 1, increasing REG number from the lowest-numbered RBs in the CORESET 1 (i.e., REG 148) till the highest-numbered RBs in the CORESET 1 (i.e., REG 171).

Similarly, in OFDM symbol 0 in Slot 2 of the CORESET 2, starting from REG 172 for the lowest-numbered RB in the CORESET 2, then increasing REG number for the second lowest-numbered RBs in the CORESET 2 (i.e., REG 173) till the highest-numbered RBs in the CORESET (i.e., REG 195); in OFDM symbol 1 in Slot 2 of the CORESET 2, increasing REG number from the lowest-numbered RBs in the CORESET 2 (i.e., REG 196) till the highest-numbered RBs in the CORESET 2 (i.e., REG 219); and then, in OFDM symbol 2 in Slot 2 of the CORESET 2, increasing REG number from the lowest-numbered RBs in the CORESET 2 (i.e., REG 220) till the highest-numbered RBs in the CORESET 2 (i.e., REG 243).

According to the embodiments of FIG. 9, NR IoT application is deployed with 5 MHz bandwidth and 15 kHz subcarrier spacing, and there are maximum 25 RBs available for transmission. Accordingly, there are maximum 25 REGs available for transmission in each OFDM symbol within each slot. In the case that there are 25 REGs available for transmission in OFDM symbol 0 in Slot 1, only the first REG (i.e., REG 100) to the twenty-fourth REG (i.e., REG 123) in OFDM symbol 0 may be configured to be included in the CORESET 1, because maximum 24 REGs are configurable for the CORESET 1. In other words, the CORESET 1 does not include the twenty-fifth REG in OFDM symbol 0 in Slot 1. Similarly, as shown in FIG. 9, the CORESET 1 does not include the twenty-fifth REG in each of OFDM symbols 1 and 2 in Slot 1. The CORESET 2 does not include the twenty-fifth REG in each of OFDM symbols 0, 1, and 2 in Slot 2. Hence, the embodiments of FIG. 9 keep 6 REGs for one CCE and keep the frequency domain resource configuration for the CORESET 1 and the CORESET 2 in a bitmap with each bit in the bitmap corresponding to 6 contiguous RBs.

It can be contemplated that each CORESET in the embodiments of FIGS. 8 and 9 may alternatively use a time-first frequency-second REG numbering manner. Details are similar to embodiments of FIG. 5.

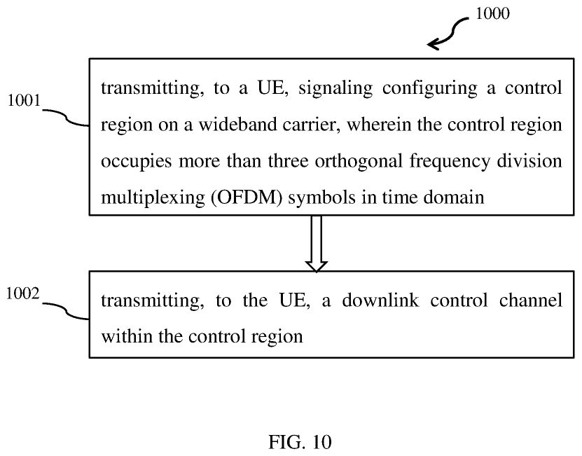

FIG. 10 illustrates a flow chart of a method for wireless communications in accordance with some embodiments of the present application.

In the exemplary method 1000 as shown in FIG. 10, in operation 1001, a BS (e.g., BS 102 as shown in FIG. 1) transmits, to a UE (e.g., UE 101a as shown in FIG. 1), signaling configuring a control region on a wideband carrier, wherein the control region occupies more than three OFDM symbols in time domain. In operation 1002, the BS transmits, to the UE, a downlink control channel within the control region. In one example, the downlink control channel is PDCCH.

Details described in all the foregoing embodiments of the present application (for example, how an IoT UE can work properly with a support of very high AL PDCCH in a narrow band) are applicable for the embodiments as shown in FIG. 10.

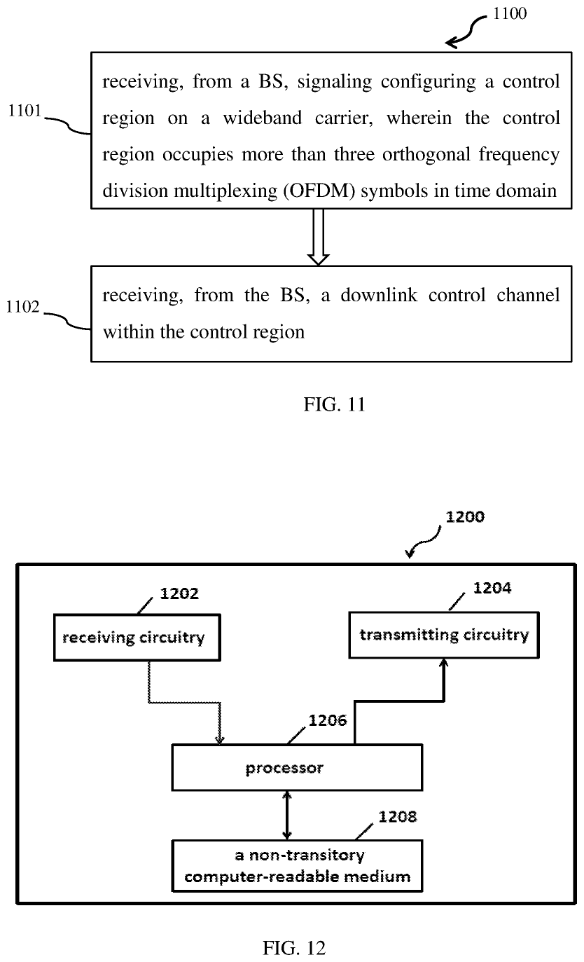

FIG. 11 illustrates another flow chart of a method for wireless communications in accordance with some embodiments of the present application.

In the exemplary method 1100 as shown in FIG. 11, in operation 1101, a UE (e.g., UE 101a as shown in FIG. 1) receives, from a BS (e.g., BS 102 as shown in FIG. 1), signaling configuring a control region on a wideband carrier, wherein the control region occupies more than three OFDM symbols in time domain. In operation 1102, the UE receives, from the BS, a downlink control channel within the control region. In one example, the downlink control channel is PDCCH.

Details described in all the foregoing embodiments of the present application (for example, how an IoT UE can work properly with a support of very high AL PDCCH in a narrow band) are applicable for the embodiments as shown in FIG. 11.

FIG. 12 illustrates a block diagram of an exemplary apparatus in accordance with some embodiments of the present application. Referring to FIG. 12, the apparatus 1200 includes a receiving circuitry 1202, a transmitting circuitry 1204, a processor 1206, and a non-transitory computer-readable medium 1208. The processor 1206 is coupled to the non-transitory computer-readable medium 1208, the receiving circuitry 1202, and the transmitting circuitry 1204.

It is contemplated that some components are omitted in FIG. 12 for simplicity. In some embodiments, the receiving circuitry 1202 and the transmitting circuitry 1204 may be integrated into a single component (e.g., a transceiver).

In some embodiments, the non-transitory computer-readable medium 1208 may have stored thereon computer-executable instructions to cause a processor to implement the operations with respect to UE(s) as described above. For example, upon execution of the computer-executable instructions stored in the non-transitory computer-readable medium 1208, the processor 1206, the receiving circuitry 1202 and the transmitting circuitry 1204 perform the method of FIG. 10, including controlling the transmitting circuitry 1204 to transmit, to a UE, signaling configuring a control region on a wideband carrier, wherein the control region occupies more than three OFDM symbols in time domain and to transmit, to the UE, a downlink control channel within the control region.

In some embodiments, the non-transitory computer-readable medium 1208 may have stored thereon computer-executable instructions to cause a processor to implement the operations with respect to BS(s) as described above. For example, upon execution of the computer-executable instructions stored in the non-transitory computer-readable medium 1208, the processor 1206, the receiving circuitry 1202 and the transmitting circuitry 1204 perform the method of FIG. 11, including controlling the receiving circuitry 1202 to receive, from a BS, signaling configuring a control region on a wideband carrier, wherein the control region occupies more than three OFDM symbols in time domain and to receive, from the BS, a downlink control channel within the control region.

The method of the present application can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which there resides a finite state machine capable of implementing the flowcharts shown in the figures may be used to implement the processor functions of the present application.

Those having ordinary skills in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. An apparatus comprising a base station (BS), the apparatus further comprising:
a transmitter that:
transmits, to a user equipment (UE), signaling configuring a control region on a wideband carrier, wherein the control region occupies more than three orthogonal frequency division multiplexing (OFDM) symbols in time domain; and
transmits, to the UE, a downlink control channel within the control region, wherein a periodicity and an offset for transmitting the downlink control channel are configured by radio resource control (RRC) signaling.

2. The apparatus of claim 1, wherein the more than three OFDM symbols are within same slot and consecutive in the time domain or not consecutive in the time domain and interrupted by one or more OFDM symbols for demodulation reference signal (DMRS).

3. (canceled)

4. (canceled)

5. The apparatus of claim 1, wherein the control region comprises a plurality of resource element groups (REGs), the REGs within the control region are numbered in increasing order in a frequency-first time-second manner, and a total number of REGs within one REG bundle in frequency domain is configured by RRC signaling.

6. (canceled)

7. The apparatus of claim 1, wherein the control region comprises a plurality of resource element groups (REGs), the REGs within the control region are numbered in increasing order in a time-first frequency-second manner, and a total number of REGs within one REG bundle in the time domain is configured by RRC signaling.

8. (canceled)

9. (canceled)

10. The apparatus of claim 1, wherein a duration in the time domain and a bandwidth in frequency domain of the control region are preconfigured or configured by RRC signaling.

11. The apparatus of claim 1, wherein the control region includes a control resource set within one slot, and the control resource set occupies a part of the wideband carrier, and the part of the wideband carrier comprises one or more contiguous or non-contiguous resource block groups (RBGs) in frequency domain, and each RBG comprises a predefined number of contiguous resource blocks in the frequency domain.

12. (canceled)

13. (canceled)

14. (canceled)

15. The apparatus of claim 12, wherein an offset between an index of the lowest numbered resource block (RB) in the control resource set and an index of a lowest numbered RB in the wideband carrier relative to same subcarrier spacing is an integer multiple of 6.

16. The apparatus of claim 1, wherein the control region includes two or more control resource sets within same slot or different slots, REGs in the two or more control resource sets are numbered across control resource sets in the same increasing order, and control-channel elements (CCEs) within the two or more control resource sets are concatenated for transmitting the downlink control channel.

17. (canceled)

18. (canceled)

19. (canceled)

20. (canceled)

21. The apparatus of claim 1, wherein the downlink control channel carries control information for scheduling system information, the control region includes at least four OFDM symbols in the time domain and twenty-four resource blocks (RBs) in frequency domain or a duration in the time domain and a bandwidth in frequency domain of the control region are indicated in master information block (MIB).

22. (canceled)

23. A method for wireless communications performed by a user equipment (UE), comprising:
receiving, from a base station (BS), signaling configuring a control region on a wideband carrier, wherein the control region occupies more than three orthogonal frequency division multiplexing (OFDM) symbols in time domain; and
receiving, from the BS, a downlink control channel within the control region, wherein a periodicity and an offset for receiving the downlink control channel are configured by radio resource control (RRC) signaling.

24. The method of claim 23, wherein the more than three OFDM symbols are within same slot and consecutive in the time domain or not consecutive in the time domain and interrupted by one or more OFDM symbols for demodulation reference signal (DMRS).

25. (canceled)

26. (canceled)

27. The method of claim 23, wherein the control region comprises a plurality of resource element groups (REGs), the REGs within the control region are numbered in increasing order in a frequency-first time-second manner, and a total number of REGs within one REG bundle in frequency domain is configured by RRC signaling.

28. (canceled)

29. The method of claim 23, wherein the control region comprises a plurality of resource element groups (REGs), the REGs within the control region are numbered in increasing order in a time-first frequency-second manner, and a total number of REGs within one REG bundle in the time domain is configured by RRC signaling.

30. (canceled)

31. (canceled)

32. The method of claim 23, wherein:
a duration in the time domain and a bandwidth in frequency domain of the control region are preconfigured or configured by RRC signaling;
the downlink control channel carries control information for scheduling system information and the control region includes at least four OFDM symbols in the time domain and twenty-four resource blocks (RBs) in frequency domain or a duration in the time domain and a bandwidth in frequency domain of the control region are indicated in master information block (MIB),
or a combination thereof.

33. The method of claim 23, wherein the control region includes a control resource set within one slot.

34. The method of claim 33, wherein the control resource set occupies a part of the wideband carrier, and the part of the wideband carrier comprises one or more contiguous or non-contiguous resource block groups (RBGs) in frequency domain, and each RBG comprises a predefined number of contiguous resource blocks in the frequency domain.

35. (canceled)

36. (canceled)

37. The method of claim 34, wherein an offset between an index of the lowest numbered resource block (RB) in the control resource set and an index of a lowest numbered RB in the wideband carrier relative to same subcarrier spacing is an integer multiple of 6.

38. The method of claim 23, wherein the control region includes two or more control resource sets within same slot or different slots.

39. (canceled)

40. (canceled)

41. The method of claim 38, wherein REGs in the two or more control resource sets are numbered across control resource sets in the same increasing order, wherein the same increasing order is a frequency-first time-second increasing order or a time-first frequency-second increasing order, and control-channel elements (CCEs) within the two or more control resource sets are concatenated for receiving the downlink control channel.

42. (canceled)

43. (canceled)

44. (canceled)

45. (canceled)

46. (canceled)

47. An apparatus comprising a user equipment (UE), the apparatus further comprising:
a receiver that:
receives, from a base station (BS), signaling configuring a control region on a wideband carrier, wherein the control region occupies more than three orthogonal frequency division multiplexing (OFDM) symbols in time domain; and
receives, from the BS, a downlink control channel within the control region, wherein a periodicity and an offset for receiving the downlink control channel are configured by radio resource control (RRC) signaling.
